(19) United States
(12) Patent Application Publication
(10) Pub. No.: US 2026/0124949 A1
(43) Pub. Date: May 7, 2026

(54) DUAL-STAGE MULTIDAY CHARGING CONTROL

(71) Applicant: GM GLOBAL TECHNOLOGY OPERATIONS LLC, Detroit, MI (US)

(72) Inventors: Daniel Urieli, Herzliya (IL); Klaus Trangbaek, Ein Vered (IL); Yaron Veksler, Giv'atayim (IL); Evi Cohen, Yokneam Illit (IL)

(73) Assignee: GM GLOBAL TECHNOLOGY OPERATIONS LLC, Detroit, MI (US)

(21) Appl. No.: 18/940,002

(22) Filed: Nov. 7, 2024

(51) Int. Cl. B60L 53/67; B60L 53/62; B60L 53/64; B60L 53/66

(52) U.S. Cl. CPC B60L 53/67; B60L 53/62; B60L 53/64; B60L 53/66; B60L 2240/72

(57) ABSTRACT

A system includes multiple charging stations, multiple fleet electric vehicles, and a computer. The charging stations are provided at a facility. The fleet electric vehicles are charged by the charging stations per a schedule. The fleet electric vehicles are operational to perform multiple tasks on multiple routes dispersed over multiple days. The computer is in communication with the charging stations and is operational to generate the schedule to charge the fleet electric vehicles over the multiple days with a two-stage process. The schedule is based on a first number of the charging stations ready to charge, a second number of the fleet electric vehicles ready to be charged, a plurality of state-of-charges in the fleet electric vehicles upon arrival and already present at the facility, and a plurality of energy consumption levels associated with the plurality of routes.

### INTRODUCTION

The present disclosure relates to a system and a method for dual-stage multiday charging control for a fleet of electric vehicles.

Ownership of a fleet of electric vehicles comes with an issue of how to determine a charging schedule for the electric vehicles. The charging schedule may be composed of time-of-use charging and peak power demand charging, each having certain advantages and disadvantages. Charging an electric vehicle during a peak power demand time of a day is less value optimal than charging the electric vehicle during a low power demand time.

Accordingly, those skilled in the art continue with research and development efforts in the field of charging management of electric vehicles.

### SUMMARY

A system is provided herein. The system includes a plurality of charging stations provided at a facility, a plurality of fleet electric vehicles, and a computer. The plurality of fleet electric vehicles are charged by the plurality of charging stations per a schedule. The plurality of fleet electric vehicles are operational to perform a plurality of tasks on a plurality of routes dispersed over a plurality of days. The computer is in communication with the plurality of charging stations and is operational to generate the schedule to charge the plurality of fleet electric vehicles over the plurality of days with a two-stage process. The schedule is based on a first number of the plurality of charging stations ready to charge, a second number of the plurality of fleet electric vehicles ready to be charged, a plurality of state-of-charges in the plurality of fleet electric vehicles upon arrival at the facility and already present at the facility, and a plurality of energy consumption levels associated with the plurality of routes.

In one or more embodiments of the system, the two-stage process includes a first stage operational to perform a plurality of searches in a combinatorial search tree to determine a complete assignment mapping of the plurality of fleet electric vehicles suited to perform the plurality of tasks, and a second stage operational to perform a scheduling process that determines the schedule for charging the plurality of fleet electric vehicles over the plurality of days based on the complete assignment mapping.

In one or more embodiments of the system, the computer is further operational to minimize the plurality of state-of-charges in the plurality of fleet electric vehicles upon departure from the facility to accomplish the plurality of tasks based on the complete assignment mapping and the schedule.

In one or more embodiments of the system, the complete assignment mapping is flexible to trade off a peak demand charging value and a time-of-use charging value while satisfying the plurality of tasks.

In one or more embodiments of the system, the computer is further operational to solve a value-minimizing aggregate for the complete assignment mapping with the scheduling process.

In one or more embodiments of the system, a number of candidate complete assignment mappings is less than a total number of possible complete assignment mappings in the combinatorial search tree.

In one or more embodiments of the system, the computer is further operational to skip one or more conflicting tasks among the plurality of tasks in the plurality of searches.

In one or more embodiments of the system, the computer is further operational to skip completion of one or more partial candidate complete assignment mappings that utilize higher peak power than a previously found candidate complete assignment mapping during the plurality of searches to determine the complete assignment mapping.

In one or more embodiments of the system, the computer is further operational to finalize the complete assignment mapping, and perform the scheduling process a single time in response to the complete assignment mapping as finalized.

In one or more embodiments of the system, the computer is further operational to present the schedules in a human readable form.

A method for dual-stage multiday charging control is provided herein. The method includes providing a plurality of charging stations at a facility, and generating a schedule to charge a plurality of fleet electric vehicles over a plurality of days by performing a two-stage process. The plurality of fleet electric vehicles are operational to perform a plurality of tasks on the plurality of routes dispersed over the plurality of days. The schedule is based on a first number of the plurality of charging stations ready to charge, a second number of the plurality of fleet electric vehicles ready to be charged, a plurality of state-of-charges in the plurality of fleet electric vehicle upon arrival at the facility and already present at the facility, and a plurality of energy consumption levels associated with a plurality of routes. The method includes charging the plurality of fleet electric vehicles with the plurality of charging stations based on the schedule.

In one or more embodiments of the method, the two-stage process includes performing a plurality of searches in a combinatorial search tree in a first stage to determine a complete assignment mapping of the plurality of fleet electric vehicles suited to perform the plurality of tasks, and performing a scheduling process in a second stage that determines the schedule for charging the plurality of fleet electric vehicles over the plurality of days based on the complete assignment mapping.

In one or more embodiments, the method includes minimizing the plurality of state-of-charges in the plurality of fleet electric vehicles upon departure from the facility to accomplish the plurality of tasks based on the complete assignment mapping and the schedule.

In one or more embodiments of the method, the complete assignment mapping are flexible to trade off a peak demand charging value and a time-of-use charging value while satisfying the plurality of tasks.

In one or more embodiments, the method includes solving a value-minimizing aggregate for the complete assignment mapping with the scheduling process.

In one or more embodiments of the method, a number of candidate complete assignment mappings is less than a total number of possible complete assignment mappings in the combinatorial search tree.

In one or more embodiments, the method includes skipping one or more conflicting tasks among the plurality of tasks in the plurality of searches.

In one or more embodiments, the method includes skipping completion of one or more partial candidate complete assignment mappings that utilize higher peak power than a previously found candidate complete assignment mapping during the plurality of searches to determine the complete assignment mapping.

In one or more embodiments, the method includes finalizing the complete assignment mapping, and performing a final scheduling process a single time in response to the finalizing of the complete assignment mapping.

A facility is provided herein. The facility includes a plurality of charging stations and a computer. The plurality of charging stations are operational to charge a plurality of fleet electric vehicles per a schedule. The plurality of fleet electric vehicles are operational to perform a plurality of tasks on a plurality of routes dispersed over a plurality of days. The computer is in communication with the plurality of charging stations and is operational to generate the schedule to charge the plurality of fleet electric vehicles over the plurality of days with a two-stage process. The schedule is based on a first number of the plurality of charging stations ready to charge, a second number of the plurality of fleet electric vehicles ready to be charged, a plurality of state-of-charges in the plurality of fleet electric vehicle upon arrival at the facility and already present at the facility, and a plurality of energy consumption levels associated with the plurality of routes. The two-stage process includes a first stage operational to perform a plurality of searches in a combinatorial search tree to determine a complete assignment mapping of the plurality of fleet electric vehicles suited to perform the plurality of tasks, and a second stage operational to perform a scheduling process that determines the schedule to charge the plurality of fleet electric vehicles over the plurality of days based on the complete assignment mapping.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram illustrating a context in accordance with one or more exemplary embodiments

FIG. 2 is a graph of a two-vehicle, three-task scenario in accordance with one or more exemplary embodiments.

FIG. 3 is a graph of simplified assignments of the tasks shown in FIG. 2 in accordance with one or more exemplary embodiments.

FIG. 4 is a flow diagram of a method to implement a two-step process to assign and schedule tasks in accordance with one or more exemplary embodiments

FIG. 5 is a schematic diagram of a combinatorial search tree for task assignments in accordance with one or more exemplary embodiments

### DETAILED DESCRIPTION

Embodiments of the disclosure generally provide a dual-stage system and/or method that provides an efficiency solution to charging a fleet of electric vehicles. The two stages include a search for flexible vehicle-to-task completed assignment mapping, and a generation of a schedule for charging the electric vehicles based on the complete assignment mapping. The schedule minimizes a multiday charging value for the complete assignment mapping. The flexibility of the complete assignment mapping is generally more computationally efficient to determine than finding an optimal assignment mapping. The flexible complete assignment mapping may also provide a scheduling program freedom to find better value-added solutions than with the less flexible assignments. Flexibility may be defined in terms of charging power used by the fleet electric vehicles to achieve assigned tasks. The flexibility induces a preference for low-peak power complete assignment mappings that allow trading off peak-demand charging with time-of-use charging. The terms “charging” and “recharging” may be used interchangeably herein.

The system/method generally involves a facility with multiple charging stations that charge multiple fleet electric vehicles according to a schedule. The fleet electric vehicles are operational to perform multiple tasks over multiple days along multiple routes. A computer is provided to generate the schedule to charge the fleet electric vehicles based on a two-stage process. A first stage of the two-stages performs multiple searches in a combinatorial search tree to determine a task-to-vehicle complete assignment mapping. A second stage performs a scheduling process that determines the schedule for charging the fleet electric vehicles over the plurality of days based on the complete assignment mapping. The schedules and complete assignment mapping may be determined by a number of charging stations ready to charge the fleet electric vehicles, a number of fleet electric vehicles ready to be charged by the charging stations, a state-of-charges (e.g., energy in the battery packs) in the fleet electric vehicles upon arrival at the facility and already at the facility, and energy consumption levels associated with the routes.

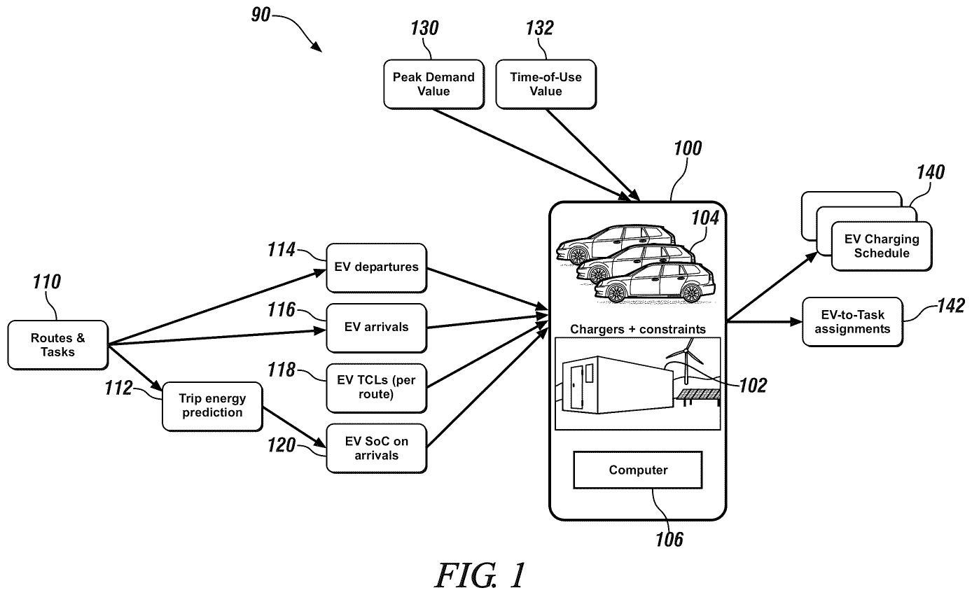

Referring to FIG. 1, a schematic diagram illustrating a context 90 is shown in accordance with one or more exemplary embodiments. The context 90 generally includes a facility 100, multiple charging stations 102 in the facility 100, multiple fleet electric vehicles (EV) 104 connectable to the charging stations 102, and a computer 106. The context 90 includes a set of routes and tasks 110 for the fleet electric vehicles 104, a trip energy prediction 112, fleet electric vehicle departures 114, fleet electric vehicle arrivals 116, fleet electric vehicle trip charge levels (TCLs) 118, and fleet electric vehicle state-of-charge (SoC) of battery packs upon arrival at the facility 100 and already at the facility 100. A peak demand value 130 and a time-of-use value 132 for supplying power to charge the fleet electric vehicles 104 is available to the computer 106. The computer 106 may generate and present a charging schedule 140 for the fleet electric vehicles and electric vehicle-to-task complete assignment mapping 142.

The facility 100 implements a fleet facility for the fleet electric vehicles 104. The facility 100 is operational to determine the complete assignment mapping 142 for the fleet electric vehicles 104 to perform various tasks along various routes, determine the charging schedule 140 for the fleet electric vehicles 104 to accomplish the tasks 110, and charge the fleet electric vehicles 104 with the charging stations 102 per the charging schedule 140.

The charging stations 102 implement electric vehicle supply equipment (EVSE). The charging stations 102 are operational to provide electrical power (e.g., electrical current at a voltage) to the fleet electric vehicles 104 to charge/recharge onboard battery packs of the fleet electric vehicles 104. In various embodiments, the charging stations 102 may be compliant with the SAE International J1772 standard and/or the International Electrotechnical Commission (IEC) 61851-1 standard. The charging stations 102 may be AC Level 1, AC Level 2, DC Level 1, and/or DC Level 2 chargers. Other charging standards may be implemented to meet the design criteria of a particular application. In some embodiments, a number of charging stations 102 may meet or exceed a number of fleet electric vehicle 104 operating from the facility 100.

The fleet electric vehicles 104 implements an electric-powered vehicle, a hybrid vehicle, or a plug-in hybrid vehicle. In various embodiments, at least four fleet electric vehicle 104 are allocated to the facility 100. In other embodiments, eight, sixteen, thirty-two or more fleet electric vehicles 104 may be allocated to the facility 100. In various embodiments, the number of tasks may be at least four tasks 110. In other embodiments, eight, sixteen, thirty-two or more tasks 110 may be available. In various embodiments, the fleet electric vehicles 104 may be compliant with the SAE International J1772 standard and/or the International Electrotechnical Commission (IEC) 61851-1 standard. The fleet electric vehicles 104 may implement AC Level 1, AC Level 2, DC Level 1, and/or DC Level 2 charging capabilities. Other standards may be implemented to meet the design criteria of a particular application. In various embodiments, the fleet electric vehicles 104 may include, but are not limited to, passenger vehicles, trucks, autonomous vehicles, and/or motorcycles. Other types of electric vehicles may be implemented to meet the design criteria of a particular application.

The computer 106 implements one or more processing circuits. The computer 106 is in communication (wired or wireless) with the charging stations 102 and in wireless communication with the fleet electric vehicles 104. The computer 106 may be in communication with a fleet management system (not shown). The processing circuits may include one or more microprocessors, each of which may be embodied as a separate processor, an application specific integrated circuit (ASIC), a field programmable gate array (FPGA), or a dedicated electronic control unit. The processing circuits may be electronic processors (implemented in hardware, software executing on hardware, or a combination of both). The processing circuits may also include tangible, non-transitory memory, (e.g., read-only memory in the form of optical, magnetic, and/or flash memory). For example, the processing circuits may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry.

Computer-readable and executable instructions embodying the present method may be recorded (or stored) in the memory and executed as set forth herein. The executable instructions may be a series of instructions employed to run applications on the processing circuits (either in the foreground or background). The processing circuits may receive commands and information, in the form of one or more input signals from various controls or components and communicate instructions to the other electronic components.

The computer 106 is operational to generate the schedule to charge the fleet electric vehicles over multiple days with a two-stage process. The schedule is based on a number of the charging stations 102 ready to charge, a number of the fleet electric vehicles 104 ready to be charged, the current of state-of-charges in the fleet electric vehicles 104 upon arrival at the facility 100 and already at the facility 100, and a number of task charge energy consumption levels associated with the routes.

Input data to the two-stage process is a set of routes and tasks 110 to be performed by the fleet electric vehicles 104. Each task may have a departure time 114, an arrival time 116 and an energy consumption (e.g., the fleet electric vehicle trip charge level 118). The battery packs of the fleet electric vehicle 104 may have state-of-charges 120 upon arrival at the facility 100. The two-stage process may also take into consideration the peak demand value 130, and the time-of-use value 132. Output data from the two-stage process may include the charging schedule 140 of the fleet electric vehicles 104 and the electric vehicle-to-task complete assignment mapping 142. In various embodiments, the electric vehicle-to-task complete assignment mapping 142 may be presented in human readable form such that personnel at the facility 100 known when and which fleet electric vehicles 104 are to be connected to the charging stations 102 for charging the battery packs.

An assignment mapping “a” maps each task to a particular fleet electric vehicle 104 with an individual assignment. Define B is the set of a total number of possible assignment mappings. Define A as a subset of B (i.e., A⊆B) of the mappings that are feasible (e.g., no vehicle is assigned overlapping tasks and charging the vehicles to meet the consumption criteria is possible.) A charging schedule c(t,v) is defined as a table of charging power for each time interval and vehicle. For an assignment mapping of “a” in A (i.e., a∈A), Cₐ is a set of charging schedules that meet the criteria. For each charging schedule “c” in Cₐ, there is an associated value f(c).

In various situations, an ideal assignment mapping a* and an ideal schedule c* minimize the value to charge the fleet electric vehicles 104 per equation 1 as follows:

$${a}^{*} , {c}^{*} = arg {min}_{a , c} f ( c ) , such that c ∈ {C}_{a} , a ∈ A \qquad Eq . ( 1 )$$

Due to the complexity of equation 1, a heuristic approach may be implemented in the computer 106 per equation 2 to calculate a complete assignment mapping â as follows:

$$\hat{a} = arg {min}_{a} {min}_{c} g ( c ) , such that c ∈ {C}_{a} , a ∈ A \qquad Eq . ( 2 )$$

The complete assignment mapping â may be referred as most flexible complete assignment mapping. The parameter g(c) may be the peak power over the time intervals and individual fleet electric vehicles 104, and is defined as follows:

$$g ( c ) = {max}_{t} {max}_{v} c ( t , v ) \qquad Eq . ( 3 )$$

A corresponding charging schedule ê may be defined as follows:

$$\hat{c} = arg {min}_{c} f ( c ) , c ∈ {C}_{\hat{a}} \qquad Eq . ( 4 )$$

The complete assignment mapping â (142) and the charging schedule ĉ (140) are easier and faster for the computer 106 to calculate than the ideal assignments mapping a* and the ideal charging schedule c*.

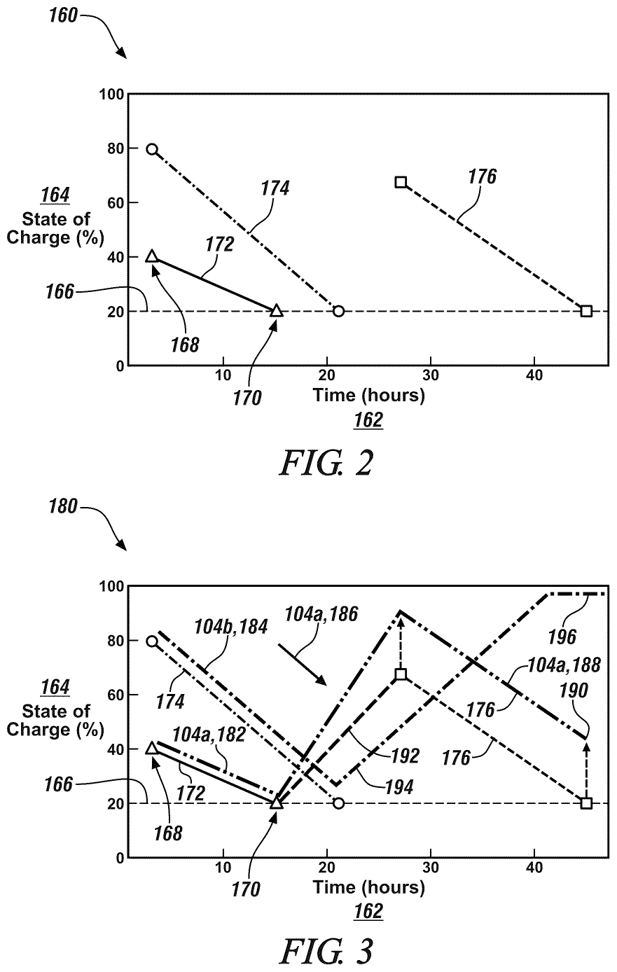

Referring to FIG. 2, a graph 160 of an example two-vehicle, three-task scenario is shown in accordance with one or more exemplary embodiments. The graph 160 may have an x-axis 162 in units of hours. A y-axis 164 is shown in percentage of state-of-charge of the battery packs of the fleet electric vehicles 104. A line 166 represents a minimum target state-of-charge for a battery pack.

Each task has a task start-time (departure time) 168 and a task end-time (arrival time) 170. The three tasks may be represented by lines 172, 174 and 176. The first task 172 and the second task 174 have a departure time at approximately 2 hours. The first task 172 has an arrival time of approximately 15 hours. The second task 174 has an arrival time of approximately 21 hours. A third task 176 has a departure time of approximately 28 hours and an arrival time of approximately 45 hours. The tasks 172, 174 and 176 end prior to the assigned fleet electric vehicles 104 reaching the minimum target state-of-charge 166.

Future tasks may be defined by the anticipated consumption corresponding to a difference between a starting state-of-charge and an ending state-of-charge. In various embodiments, the ending state-of charge is limited to the minimum target state-of-charge 166 (e.g., approximately 20%). Since the first task 172 and the second task 174 overlap in time and the corresponding paths do not overlap, the first task 172 and the second task 174 are assigned to different fleet electric vehicles 104. Between tasks, fleet electric vehicles 104 follow a charging schedule that achieves a desired charge level by a subsequent departure time for a new task.

Referring to FIG. 3, a graph 180 of example simplified assignments of the tasks shown in FIG. 2 is shown in accordance with one or more exemplary embodiments. The graph 180 may have the x-axis 162 in units of hours. The y-axis 164 is shown in percentage of state-of-charge of the battery packs of the fleet electric vehicles 104. The line 166 represents a minimum target state-of-charge for a battery pack. The tasks 172, 174 and 176 from FIG. 2 are also illustrated.

To accomplish the tasks 172, 174 and 176, the computer 106 may assign a first fleet electric vehicle 104a to the first task 172 and the non-overlapping third task 176. A second fleet electric vehicle 104b may be assigned to the second task 174. As the first task 172 is performed by the first fleet electric vehicle 104a, a state-of-charge of the battery pack in the first fleet electric vehicle 104a decreases, as illustrated by a line 182, until the first task 172 is complete. As the second fleet electric vehicle 104b performs the second task 174, a state-of-charge of the battery pack in the second fleet electric vehicle 104b decreases, as illustrated by a line 184, until the second task 174 is complete. No intermediate charges are performed during the first task 172 and the second task 174.

With the first task 172 complete, the first fleet electric vehicle 104a may be connected to a charging station 102 and undergo a first charging schedule 186. In the example, the first charging schedule 186 may have a first charge rate (e.g., slope of line 186) to increase the state-of-charge to a level beyond what is sufficient to perform the third task 176. Upon completion of the third task 176, the battery pack of the first fleet electric vehicle 104a may be at a level 190 above the minimum target state-of-charge line 166. In various embodiments, a different charging schedule 192 may be used to charge the first fleet electric vehicle 104a to the minimal level sufficient to perform the third task 176. Upon completion of the third task 176, the battery pack of the first fleet electric vehicle 104a may be at the minimum target state-of-charge line 166 and so unavailable for another task until after the battery pack is charged again.

With the second task 174 complete, the second fleet electric vehicle 104b may be connected to a charging station 102 and undergo a second charging schedule 194. In the example, the second charging schedule 194 may be at a different (e.g., lower) charge rate than the first charging schedule 186. The second charging schedule 194 may charge the battery pack of the second fleet electric vehicle 104b to near full charge 196. The second fleet electric vehicle 104b may remain at the near full charge 196 until another task is assigned and performed.

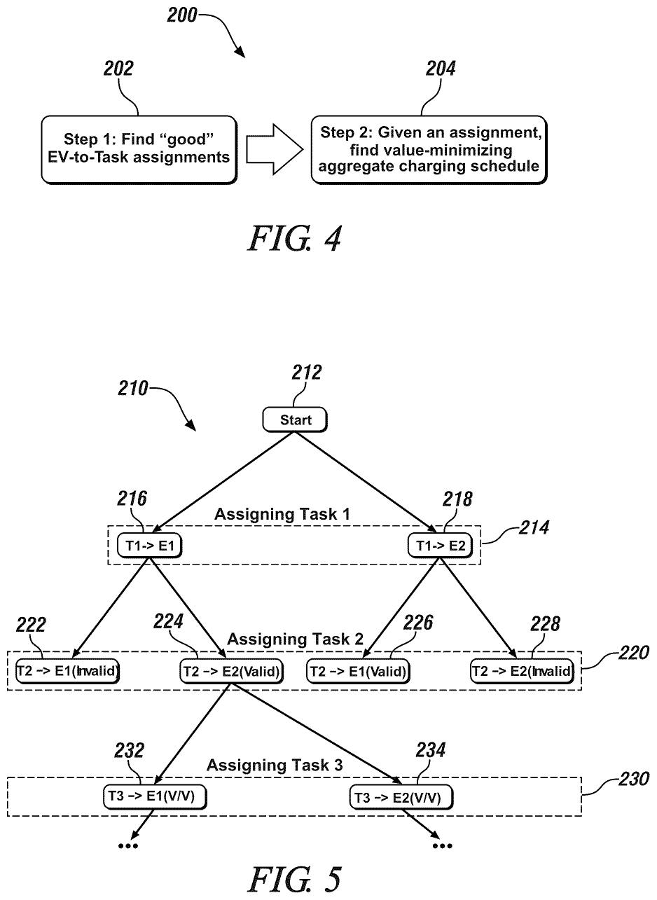

Referring to FIG. 4, a flow diagram of an example method 200 to implement a two-step process to assign and schedule tasks is shown in accordance with one or more exemplary embodiments. The method 200 (or process) may be implemented in the computer 106. The method 200 generally include steps 202 to 204, as illustrated.

In the step 202, “flexible” complete assignment mapping is efficiently found between the fleet electric vehicles 104 and the routes and tasks 110 (FIG. 1) to be performed. Ideally, the complete assignment mapping may minimize the resources utilized to charge the fleet electric vehicles 104 selected to perform the tasks 110. A simple approach would be to run an assignment program that considers every possible solution to find a solution that minimizes the value of charging the fleet electric vehicles 104. However, an exponential number of candidates for an ideal complete assignment mapping are considered based on the number of the fleet electric vehicles 104. For example, given 30 tasks and 120 fleet electric vehicles 104 to account for, there are approximately 30¹²⁰ possible solutions to evaluate. Therefore, the step 202 may limit the possible solutions to consider in order to simplify the calculations performed by the computer 106. The resulting electric vehicle-to-task complete assignment mapping 142 (FIG. 1) may be presented in the facility 100.

In various embodiments, a “good” assignment mapping (e.g., ideal value-optimal assignments) may be relaxed to a “flexible” complete assignment mapping. The flexible complete assignment mapping is generally less computationally complex as the ideal assignment mapping and may enable the scheduling program freedom to find reasonable solutions. A “flexible” complete assignment mappings may be defined as an assignment mapping that result in a minimal energy consumption for the facility 100. The flexible complete assignment mapping may be computed efficiently in linear time.

In various embodiments, the flexible complete assignment mapping involves multiple searches in a combinatorial search tree. To avoid traversing the entire combinatorial search tree, subtrees may be pruned. The pruning may involve skipping conflicting (overlapping) tasks and/or skipping completion of partial assignments that utilize more energy than a lowest energy found in an earlier search. Therefore, the number of candidate assignments considered is less than a total number of possible assignments in the combinatorial search tree. The assignment program may be run a single final time on the pruned combinatorial search tree to determine final energy minimizing complete assignment mapping.

In the step 204, a final scheduling program is run (e.g., a single time) to identify a value-minimizing aggregate charging schedule given the complete assignment mapping from step 202. The resulting charging schedule 140 (FIG. 1) is used in the facility 100 to determine which fleet electric vehicles 104 are connect to the charging station 102 and when.

Referring to FIG. 5, a schematic diagram of an example combinatorial search tree 210 for task assignments is shown in accordance with one or more exemplary embodiments. In the example, the combinatorial search tree 210 assigns three tasks T1, T2 and T3 (tasks 172, 174 and 176 in FIG. 3) among the available fleet electric vehicles E1, E2, E3, . . . , and so on. The combinatorial search tree 210 has a starting node 212. The first task T1 may be assigned in a layer 214. In particular, the first task T1 may be assigned to the first fleet electric vehicle E1 in the node 216. The first task T1 may also be assigned to the second fleet electric vehicle E2 in the node 218.

The combinatorial search tree 210 continues with assigning the second task T2 in the level 220. In the level 220, the node 216 branches to a node 222 and a node 224. The node 222 considers a potential candidate assignment of the second task T2 to the first fleet electric vehicle E1 as invalid as the first task T1 and the second task T2 may overlap (e.g., see tasks 172 and 174 in FIG. 3). The node 224 considers a potential candidate assignment of the second task T2 to a second fleet electric vehicle E2 valid. Node 226 determines that the second task T2 may be validly assigned to the first fleet electric vehicle E1 because node 218 assigns the first task T1 to the second fleet electric vehicle E2. Node 228 concludes that potentially assigning the second task T2 to the second fleet electric vehicle E2 is invalid as the node 218 already assigned the first task T1 to the second fleet electric vehicle E2.

The combinatorial search tree 210 continues with assigning the third task T3 in the level 230. In the level 230, the node 224 branches to a node 232 and a node 234. The node 232 considers a potential candidate assignment of the third task T3 to the first fleet electric vehicle E1 as valid as the first task T1 will have completed by the time the third task T3 is scheduled to start. The node 234 determine the potential candidate assignment of the third task T3 to the second fleet electric vehicle E2 valid as the second fleet electric vehicle E2 has not been assigned along the path from node 212 to 216 to 224 to 234. The process of determining the complete assignment mapping in the combinatorial search tree 210 may continue until the tasks have been assigned to the fleet electric vehicles.

By way of example, a pseudo code for a dual-stage multiday charging optimization technique is provided. The technique is a variation of a recursive backtracking search for constraint satisfaction problems (CSPs) as follows:

```
  Input: task_list, EV_list, overlap_check:
  Initialize best_energy = infinite, assignment = { }, best_assignment = None
  Function backtracking_search (CSP):
    Return recursive_backtracking (assignment={ }, csp)
  Function recursive_backtracking (assignment, csp):
    If csp.is complete (assignment):
      Best_energy, best_assignment = update_best_energy_and_assignment
(assignment) return
    Task = csp.select_unassigned_task (assignment)
    For each EV in csp.order_possible_EVs (task, assignment):
      If csp.no_overlap_and_energy_suffices (task, EV, assignment,
best_energy):
        Assignment.add (task => EV)
        Csp_copy = copy(csp)
        Valid = csp_copy.enforce_no_overlapping_tasks_per_EV (assignment)
        If valid:
          Recursive_backtracking (assignment, csp_copy)
        Assignment-remove (task => EV)
    Return
  Valid_values = { }
  For each task in task_list:
    Valid_values[task} = EV_list
  Csp = CSP(task_list, valid_values)
  Recursive_backtracking (csp)
  Value_minimizing_charging_schedule = run program (best_assignment)
```

Saving resources for ownership of fleet electric vehicles enhances fleet services software that is sold with the fleet electric vehicles. To reduce resource expenditures, fleet managers may distribute charging of the battery packs in the fleet electric vehicles over time. Computing an ideal multiday charging schedule is computationally difficult so a flexible approach is implemented. Optimization of the fleet charging resources is performed in two stages: first stage, finding flexible electric vehicle-to-task complete assignment mapping, and second stage, solving a scheduling program for a multiday electric vehicle charging schedule. Therefore, the system generally provides improvements in the field of power/charging management. The flexible assignments provide improvements in the field of computer sciences.

Embodiments of the disclosure generally provide a dual-stage framework for optimizing fleet charging resources. The framework finds a flexible (e.g., low peak power electric vehicle-to-assignment mapping, and uses the complete assignment mapping to define and solve a scheduling program for a multiday electric vehicle charging schedule. The first stage may prune a combinatorial search tree by skipping subtrees in which there are overlapping tasks for the same vehicle, and utilize more energy than a lowest energy of previous assignments. The second stage automatically generates a scheduling program that utilizes the complete assignment mapping from the first stage.

Numerical values of parameters (e.g., of quantities or conditions) in this specification, including the appended claims, are to be understood as being modified in each instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. A system comprising:
a plurality of charging stations provided at a facility;
a plurality of fleet electric vehicles that are charged by the plurality of charging stations per a schedule, wherein:
the plurality of fleet electric vehicles are operational to perform a plurality of tasks on a plurality of routes dispersed over a plurality of days; and
a computer in communication with the plurality of charging stations and operational to generate the schedule to charge the plurality of fleet electric vehicles over the plurality of days with a two-stage process, wherein the schedule is based on:
a first number of the plurality of charging stations ready to charge;
a second number of the plurality of fleet electric vehicles ready to be charged;
a plurality of state-of-charges in the plurality of fleet electric vehicles upon arrival at the facility and already present at the facility; and
a plurality of energy consumption levels associated with the plurality of routes.

2. The system according to claim 1, wherein the two-stage process comprises:
a first stage operational to perform a plurality of searches in a combinatorial search tree to determine a complete assignment mapping of the plurality of fleet electric vehicles suited to perform the plurality of tasks; and
a second stage operational to perform a scheduling process that determines the schedule for charging the plurality of fleet electric vehicles over the plurality of days based on the complete assignment mapping.

3. The system according to claim 2, wherein the computer is further operational to:
minimize the plurality of state-of-charges in the plurality of fleet electric vehicles upon departure from the facility to accomplish the plurality of tasks based on the complete assignment mapping and the schedule.

4. The system according to claim 2, wherein the complete assignment mapping is flexible to trade off a peak demand charging value and a time-of-use charging value while satisfying the plurality of tasks.

5. The system according to claim 2, wherein the computer is further operational to:
solve a value-minimizing aggregate for the complete assignment mapping with the scheduling process.

6. The system according to claim 2, wherein:
a number of candidate complete assignment mappings is less than a total number of possible complete assignment mappings in the combinatorial search tree.

7. The system according to claim 2, wherein the computer is further operational to:
skip one or more conflicting tasks among the plurality of tasks in the plurality of searches.

8. The system according to claim 2, wherein the computer is further operational to:
skip completion of one or more partial candidate complete assignment mappings that utilize higher peak power than a previously found candidate complete assignment mapping during the plurality of searches to determine the complete assignment mapping.

9. The system according to claim 2, wherein the computer is further operational to:
finalize the complete assignment mapping; and
perform the scheduling process a single time in response to the complete assignment mapping as finalized.

10. The system according to claim 2, wherein the computer is further operational to present the schedules in a human readable form.

11. A method for dual-stage multiday charging control comprising:
providing a plurality of charging stations at a facility;
generating a schedule to charge a plurality of fleet electric vehicles over a plurality of days by performing a two-stage process, wherein:
the plurality of fleet electric vehicles are operational to perform a plurality of tasks on the plurality of routes dispersed over the plurality of days; and
the schedule is based on:
a first number of the plurality of charging stations ready to charge;
a second number of the plurality of fleet electric vehicles ready to be charged;
a plurality of state-of-charges in the plurality of fleet electric vehicle upon arrival at the facility and already present at the facility; and
a plurality of energy consumption levels associated with a plurality of routes; and
charging the plurality of fleet electric vehicles with the plurality of charging stations based on the schedule.

12. The method according to claim 11, wherein the two-stage process comprises:
performing a plurality of searches in a combinatorial search tree in a first stage to determine a complete assignment mapping of the plurality of fleet electric vehicles suited to perform the plurality of tasks; and
performing a scheduling process in a second stage that determines the schedule for charging the plurality of fleet electric vehicles over the plurality of days based on the complete assignment mapping.

13. The method according to claim 12, further comprising:
minimizing the plurality of state-of-charges in the plurality of fleet electric vehicles upon departure from the facility to accomplish the plurality of tasks based on the complete assignment mapping and the schedule.

14. The method according to claim 12, wherein the complete assignment mapping is flexible to trade off a peak demand charging value and a time-of-use charging value while satisfying the plurality of tasks.

15. The method according to claim 12, further comprising:
solving a value-minimizing aggregate for the complete assignment mapping with the scheduling process.

16. The method according to claim 12, wherein:
a number of candidate complete assignment mappings is less than a total number of possible complete assignment mappings in the combinatorial search tree.

17. The method according to claim 12, further comprising:
skipping one or more conflicting tasks among the plurality of tasks in the plurality of searches.

18. The method according to claim 12, further comprising:
skipping completion of one or more partial candidate complete assignment mappings that utilize higher peak power than a previously found candidate complete assignment mapping during the plurality of searches to determine the complete assignment mapping.

19. The method to claim 12, further comprising:
finalizing the complete assignment mapping; and
performing a final scheduling process a single time in response to the finalizing of the complete assignment mapping.

20. A facility comprising:
a plurality of charging stations operational to charge a plurality of fleet electric vehicles per a schedule, wherein
the plurality of fleet electric vehicles are operational to perform a plurality of tasks on a plurality of routes dispersed over a plurality of days; and
a computer in communication with the plurality of charging stations and operational to generate the schedule to charge the plurality of fleet electric vehicles over the plurality of days with a two-stage process, wherein the schedule is based on:
a first number of the plurality of charging stations ready to charge;
a second number of the plurality of fleet electric vehicles ready to be charged;
a plurality of state-of-charges in the plurality of fleet electric vehicle upon arrival at the facility and already present at the facility; and
a plurality of energy consumption levels associated with the plurality of routes; and
wherein the two-stage process comprises:
a first stage operational to perform a plurality of searches in a combinatorial search tree to determine a complete assignment mapping of the plurality of fleet electric vehicles suited to perform the plurality of tasks; and
a second stage operational to perform a scheduling process that determines the schedule to charge the plurality of fleet electric vehicles over the plurality of days based on the complete assignment mapping.
